(19) United States
(12) Patent Application Publication
(10) Pub. No.: US 2020/0043112 A1
(43) Pub. Date: Feb. 6, 2020

(54) Streamlining Drafting Process

(71) Applicant: James L. Brinkley, II, Upper Marlboro, MD (US)

(72) Inventor: James L. Brinkley, II, Upper Marlboro, MD (US)

(73) Assignee: JB Tek Group LLC, Upper Marlboro, MD (US)

(21) Appl. No.: 16/054,993

(22) Filed: Aug. 3, 2018

(51) Int. Cl. G06Q 50/18; G06Q 10/10; G06F 15/18; G06K 9/00; G06F 17/30

(52) U.S. Cl. CPC G06Q 50/184; G06Q 10/10; G06F 2216/11; G06K 9/00335; G06F 17/30011; G06F 15/18

(57) ABSTRACT

In an approach for streamlining the patent application drafting process, a processor receives information relevant to drafting a document, wherein the information includes user input about an invention to be patented and prior art related to the invention, and wherein the document includes one or more sections of a patent application. A processor receives guidelines and standards of patentability. A processor analyzes the received information. A processor determines the patentability of the invention, based on the analyzed received information. A processor generates the document for the invention, based on a learned behavior. A processor sends the generated document to the user.

### BACKGROUND

The present invention relates generally to the field of patent drafting, and more particularly to streamlining the patent application drafting process.

A patent is a set of exclusive rights granted by a sovereign state or intergovernmental organization to an inventor or assignee for a limited period of time in exchange for detailed public disclosure of an invention. An invention is a solution to a specific technological problem. A patent is an intellectual property right granted to anyone who invents any new, useful, and non-obvious process, machine, article of manufacture, or composition of matter. This intellectual property right gives the inventor the right to exclude others from making, using, selling, offering for sale, or importing the patented invention for the term of the patent.

A patent application is a request pending at a patent office for the grant of a patent for the invention described and claimed by that application. An application consists of a description of the invention, together with official forms and correspondence relating to the application. The term patent application is also used to refer to the process of applying for a patent, or to the patent specification itself (i.e., the content of the document filed with a view to initiating the process of applying for a patent).

The patent application process includes searching for prior art, drafting and filing the patent application, and prosecuting the patent application in the United States Patent and Trademark Office (USPTO), or other patent offices. Patent prosecution is the process of negotiating and arguing with a patent office for the grant of a patent and interaction with a patent office with regard to a patent after its grant.

Artificial intelligence (AI) is intelligence demonstrated by machines. In computer science, AI research is defined as the study of intelligent agents: any device that perceives its environment and takes actions that maximize its chance of successfully achieving its goals. Colloquially, AI is applied when a machine mimics cognitive functions that humans associate with other human minds, such as learning and problem solving.

The traditional problems, or goals, of AI research include: automated reasoning; knowledge representation and reasoning; machine learning; natural language processing; machine perception; computer vision; and the ability to move and manipulate objects. Approaches include symbolic AI; deep learning; statistical methods; computational intelligence; and traditional symbolic AI. Many tools are used in AI, including versions of search and mathematical optimization, artificial neural networks, and methods based on statistics, probability, and economics. The AI field draws upon computer science, mathematics, psychology, linguistics, and philosophy.

### SUMMARY

Aspects of an embodiment of the present invention disclose a method, computer program product, and computing system for streamlining the patent application drafting process. A processor receives information relevant to drafting a document, wherein the information includes user input about an invention to be patented and prior art related to the invention, and wherein the document includes one or more sections of a patent application. A processor receives guidelines and standards of patentability. A processor analyzes the received information. A processor determines the patentability of the invention, based on the analyzed received information. A processor generates the document for the invention, based on a learned behavior. A processor sends the generated document to the user.

### BRIEF DESCRIPTION OF THE DRAWINGS

FIG. 1 depicts a block diagram of a computing system, in accordance with an embodiment of the present invention.

FIG. 2 depicts a flowchart of the steps of a generation program, executing within the computing system of FIG. 1, for streamlining the patent application drafting process.

FIG. 3 depicts a block diagram of components of the server and/or the computing devices of FIG. 1, in accordance with an embodiment of the present invention.

### DETAILED DESCRIPTION

Currently, drafting patent applications can be tedious, cumbersome, time-consuming, and expensive. Embodiments of the present invention recognize that streamlining the patent drafting process is extremely important. Embodiments of the present invention recognize that in moving towards the future, more and more inventions will be created, causing the need for more and more patent applications to be drafted. Embodiments of the present invention are useful for everyone involved in the patent drafting process, i.e., solo inventors, small businesses, law firms, corporations, examiners, governmental agencies, etc. Embodiments of the present invention allow inventors with little money and no resources to produce a quality patent application needed to secure the proper intellectual property rights for their inventions. Furthermore, embodiments of the present invention allow law firms and corporations to invest more time and money in other areas of business, while still producing quality patent applications. For example, more patent attorneys could concentrate on patent prosecution and litigation, as opposed to patent drafting. Additionally, patent groups may become smaller at law firms, and the law firms could pass on monetary savings to their clients.

Embodiments of the present invention suggest the use of various technologies to make the patent process easier (while improving the quality), more affordable by decreasing associated costs, and more efficient than the current state of the art by producing more patent applications in a lesser amount of time, while still upholding the standards of quality and integrity. Embodiments of the present invention disclose an approach for streamlining the patent application drafting process.

Embodiments of the present invention will now be described in detail with reference to the Figures.

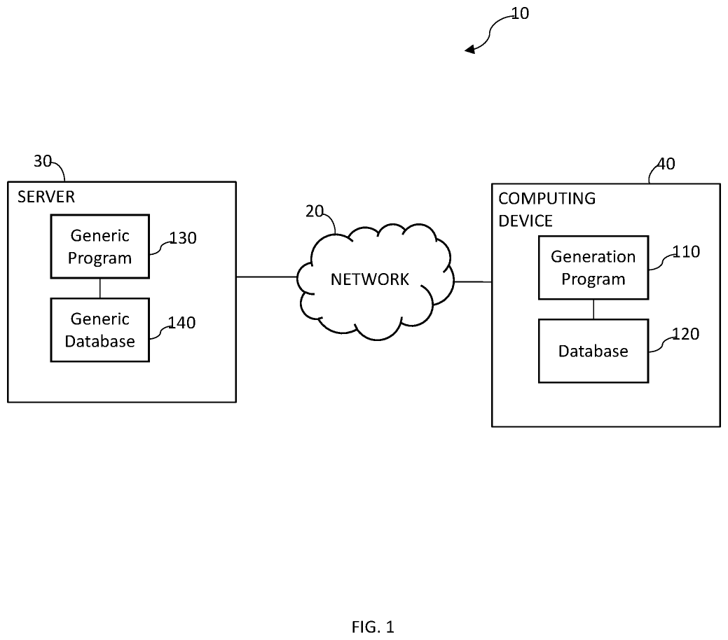

FIG. 1 depicts a block diagram of computing system 10, in accordance with one embodiment of the present invention. FIG. 1 provides an illustration of one embodiment and does not imply any limitations with regard to the environments in which different embodiments may be implemented.

In the depicted embodiment, computing system 10 includes server 30 and computing device 40 interconnected over network 20. Network 20 may be a local area network (LAN), a wide area network (WAN) such as the Internet, a cellular data network, any combination thereof, or any combination of connections and protocols that will support communications between server 30 and computing device 40, in accordance with embodiments of the present invention. Network 20 may include wired, wireless, or fiber optic connections. Computing system 10 may include additional computing devices, servers, or other devices not shown.

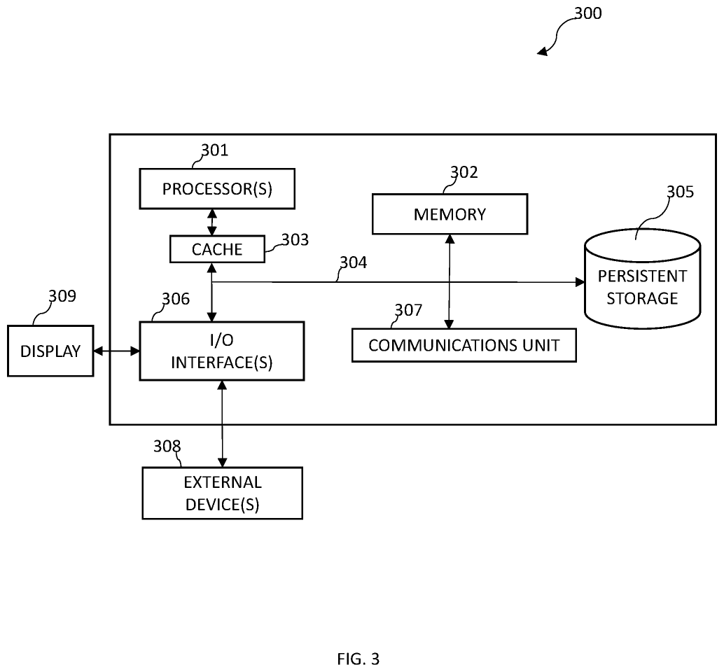

Server 30 may be a management server, a web server, or any other electronic device or computing system capable of processing program instructions and receiving and sending data. In some embodiments, server 30 may be a laptop computer, tablet computer, netbook computer, personal computer (PC), a desktop computer, or any programmable electronic device capable of communicating with computing device 40 via network 20. In other embodiments, server 30 may represent a server computing system utilizing multiple computers as a server system, such as in a cloud computing environment. In another embodiment, server 30 represents a computing system utilizing clustered computers and components to act as a single pool of seamless resources. In the depicted embodiment, server 30 contains generic program 130 and generic database 140. In other embodiments, server 30 may include generic program 130, generic database 140, and/or other components, as depicted and described in further detail with respect to FIG. 3.

Computing device 40 may be a personal device (e.g., mobile phone or smartphone), desktop computer, laptop computer, netbook computer, or tablet computer. In general, computing device 40 may be any electronic device or computing system capable of processing program instructions, sending and receiving data, and communicating with other devices over a network. In the depicted embodiment, computing device 40 contains generation program 110 and database 120. In other embodiments, computing device 40 may include generation program 110, database 120, and/or other components, as depicted and described in further detail with respect to FIG. 3.

Generation program 110 streamlines the patent application drafting process. In doing so, generation program 110 receives information relevant to the patent application drafting process. Generation program 110 analyzes the received information that is relevant to the patent application drafting process. Generation program 110 determines patentability of an invention. Generation program 110 generates a patent application. Generation program 110 sends the patent application to a user. In the depicted embodiment, generation program 110 resides on computing device 40. In other embodiments, generation program 110 may reside on another computing device, server 30, or another server, provided that generation program 110 can access database 120, generic program 130, and generic database 140.

Database 120 may be a repository that may be written to and/or read by generation program 110. In some embodiments, generation program 110 may retrieve data for previous patent applications drafted by someone at a particular firm and store the data to database 120. In other embodiments, database 120 may store information about patentability standards and guidelines. In the depicted embodiment, database 120 resides on computing device 40. In other embodiments, database 120 may reside on another computing device, server 30, or another server, provided that database 120 is accessible to generation program 110.

Generic program 130 may be any program on server 30 that may be accessed by generation program 110 over network 20. For example, generic program 130 may be an application or program that is designed to obtain information concerning the patent application drafting process, such as granted patent applications, pending patent applications, and patent laws and rules. Generation program 110 may use current information gathered by generic program 130 to assist in efficiently generating a quality patent application. In the depicted embodiment, generic program 130 resides on server 30. In other embodiments, generic program 130 may reside on another server or another computing device, provided that generic program 130 is accessible to generation program 110.

Generic database 140 may be any database on server 30 that may be accessed by generation program 110 over network 20. For example, generic database 140 may be a repository that stores granted patent applications, pending patent applications, patent laws and rules, patentability standards and guidelines, and writing styles obtained by a program or application. Generation program 110 may use archived information stored to generic database 140 to assist in efficiently generating a quality patent application. In the depicted embodiment, generic database 140 resides on server 30. In other embodiments, generic database 140 may reside on another server or another computing device, provided that generic database 140 is accessible to generation program 110.

Embodiments of the present invention may include multiple servers 30, computing devices 40, databases 120, generic programs 130, and generic databases 140.

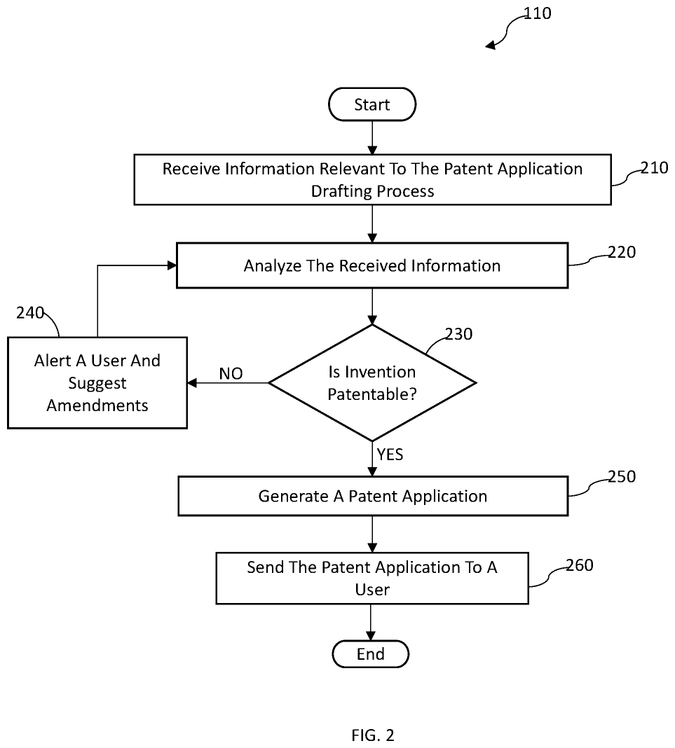

FIG. 2 depicts a flowchart of the steps of a generation program, executing within the computing system of FIG. 1, in accordance with an embodiment of the present invention. Generation program 110 streamlines the patent application drafting process.

In step 210, generation program 110 receives information relevant to the patent application drafting process. Information includes, but is not limited to: technology of the invention, completed questionnaire about the invention (previously supplied), drawings, white papers, presentations, inventor notes, patent applications, patents, articles, etc.

In one embodiment, generation program 110 receives information directly from user input. In other embodiments, generation program 110 retrieves information (e.g., using a crawling function) from various databases and/or websites (e.g., Public or Private Patent Application Information Retrieval (PAIR), any patent search website/server/database, dictionaries, thesauruses, previous patent applications written to show how a company/firm/individual likes to write, scientific journals, technology specific literature, textbooks, or any other place to obtain information to assist in drafting a patent application). In some embodiments, generation program 110 receives, or retrieves from the various databases and/or websites, information that assists in determining patentability (e.g., guidelines/standards of patentability and patent laws and rules). Examples of the various databases and/or websites may be located at database 120, generic program 130, and/or generic database 140.

In one embodiment, generation program 110 receives information through voice recognition. For example, a user may speak (e.g., through a microphone within a computer) and generation program 110 picks up the information from the user's voice. In one embodiment, the voice recognition aspect may be personalized to pick up information from a particular user's voice. In such an embodiment, generation program 110 may receive information from the user throughout various steps of the present invention to generate a patent application. When the voice recognition aspect is personalized to a particular user, generation program 110 may prevent other users from inputting information through voice recognition.

In other embodiments, generation program 110 receives information through optical character recognition (OCR), wherein generation program 110 converts images of typed, handwritten, or printed text into machine-encoded text, whether from a scanned document, photo of a document, scene-photo, or subtitle text superimposed on an image.

In some embodiments, generation program 110 receives information through computer vision, wherein generation program 110 acquires, processes, analyzes, and understands digital images and extraction of high-dimensional data from the real world in order to produce numerical or symbolic information (e.g., in the form of decisions). Understanding in this context means the transformation of visual images (the input of the retina) into descriptions of the world that can interface with other thought processes and elicit appropriate action. The image data can take many forms, such as video sequences, views from one or more cameras (e.g., a camera embedded within, or attached to, a computer), or multi-dimensional data.

In some embodiments, when it comes to subscription-/private-based patent search sources, such as Private PAIR, generation program 110 creates a prompt where the user can sign in to the user's account to add a source of search for generation program 110. In other embodiments, generation program 110 may receive a license from the subscription-/private-based patent search source (i.e., a license may be obtained previously to allow generation program 110 to access the subscription-/private-based patent search source) to add a source of search for generation program 110.

In some embodiments, generation program 110 receives various work product from various law firms, practitioners, inventors, scientists, etc. to add to a database, such as database 120 or generic database 140. Work product may include patent applications, notes, papers, presentations, or anything else that may have been produced from work.

In some embodiments, generation program 110 compiles and archives the received information and stores to a database, such as database 120 or generic database 140.

In step 220, generation program 110 analyzes the received information that is relevant to the patent application drafting process.

In one embodiment, generation program 110 analyzes the received information and learns over time through ontologies within information science, big data, analytics, information retrieval, natural language processing (NLP), natural language understanding and generation, speech recognition, artificial neural networks, machine learning, cognition, deep learning, artificial intelligence, OCR, computer vision, blockchains, and/or cryptography. A person skilled in the art would understand how each above-technology is used to analyze the received information and/or learn over time using said above-technology.

In one embodiment, generation program 110 learns the uniqueness/style of how a specific user drafts a patent application and mimics the uniqueness/style of how the specific user drafts the patent application over time. In other embodiments, generation program 110 learns how to generally draft a patent application from receiving specific guidelines of patent application drafting.

In one embodiment, generation program 110 analyzes the received information by crawling through the received information to place the information into categories for use. For example, categories may include information to help draft the claims, information to help draft the detailed description, information help determine patentability, etc. In some embodiments, generation program 110 analyzes the received information by comparing the received information that is relevant to the invention at hand to the received information that is used to assist in determining patentability.

In decision 230, generation program 110 determines patentability of an invention. The patentability requirements (i.e., guidelines/standards of patentability) mandate that the subject matter of a claimed invention be: (1) patent eligible; (2) useful; (3) new; (4) non-obvious; and (5) described with the particularity required so that people of ordinary skill in the relevant technology field or science can understand what the invention is, make the invention, and use the invention without engaging in undue experimentation. Generation program 110 determines patentability of the invention by using the information about the invention at hand and the analysis of the received information and comparing the information about the invention at hand and the analysis to the received guidelines/standards of patentability and to the prior art related to the invention.

In one embodiment, generation program 110 determines patentability using a scale (e.g., a scale of 0-5) to reach a predetermined threshold score for patentability (e.g., a user or generation program 110 may determine a number for the threshold score of patentability during the receiving step or at any other prior time). For example, for a predetermined threshold scaled score of 3, if generation program 110 determines the scaled score is 3 or above, then the invention is said to be patentable—with increasing patentability as the number increases. However, if generation program 110 determines the scaled score is below 3, then the invention is said to be unpatentable. The more the scaled score is above 3, the more patentable the invention and the more likely the invention will eventually receive the grant of a patent.

If generation program 110 determines the invention is not patentable (i.e., unpatentable), then generation program 110 alerts a user that the invention is not patentable (according to the predetermined threshold) and suggests ways to make the invention patentable (step 240). In one embodiment, generation program 110 automatically makes the necessary changes to make the invention patentable (according to the predetermined threshold), based on the learned behavior and/or writing style of the user. In other embodiments, generation program 110 makes suggestions to the user of things that the user may do to amend the invention to bring the scaled score above the predetermined threshold score for patentability and make the invention patentable (according to the predetermined threshold).

In some embodiments, if generation program 110 determines the invention is not patentable, generation program 110 loops back around to step 220 until a predetermined time and/or action takes place. Examples of the predetermined action may be, but are not limited to: the invention meeting the predetermined threshold score for patentability; the invention reaching a certain score within the given scale of patentability (e.g., even if it does not reach the predetermined threshold score for patentability); and the invention going through the loop for a certain number of times (e.g., the user or generation program 110 may determine during the receiving step that generation program 110 will only loop back around to step 220 three times before the program ends if patentability cannot be reached within the three times). In one embodiment, after the predetermined time and/or action takes place, generation program 110 ends.

If generation program 110 determines the invention is patentable, then generation program 110 generates a patent application (step 250). In one embodiment, generation program 110 generates one section of a patent application (i.e., specification, detailed description, claims, abstract, summary, background, drawings, etc.). In some embodiments, generation program 110 generates more than one section of a patent application (e.g., the entire patent application).

In step 260, generation program 110 sends the patent application to a user. In one embodiment, generation program 110 sends the patent application to the user by any known means of sending a document. Generation program 110 may send the patent application to the user by, but not limited to: email, pop up box, text message, etc. In some embodiments, generation program 110 sends the patent application to the United States Patent and Trademark Office (USPTO), or other patent office, after approval from the user. In one embodiment, generation program 110 receives, from the user, an initial general approval of all patent applications that receive a scaled score above the patentability threshold to be sent directly to the USPTO, or other patent office, upon completion/generation. In other embodiments, generation program 110 receives, from the user, a separate approval for each generated patent application. In some embodiments, generation program sends the patent application to a different third party (e.g., an inventor, client, or anyone who has an interest in the invention). In such embodiments where it is required to receive approval from the user, generation program 110 creates a prompt, requesting approval from the user where the user may approve or deny.

In other embodiments, generation program 110 may use a similar method and technology to streamline other processes and generate other documents, such as, litigation documents, patent prosecution documents, etc.

FIG. 3 depicts computer system 300, which is an example of a system that includes components of server 30 and/or computing device 40. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307. Generic program 130 and generic database 140 may be downloaded to persistent storage 305 of server 30 through communications unit 307 of server 30. Generation program 110 and database 120 may be downloaded to persistent storage 305 of computing device 40 through communications unit 307 of computing device 40.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., generic program 130 and generic database 140, can be stored on such portable computer readable storage media and can be loaded onto persistent storage 305 of server 30 via I/O interface(s) 306 of server 30. Software and data used to practice embodiments of the present invention, e.g., generation program 110 and database 120, can be stored on such portable computer readable storage media and can be loaded onto persistent storage 305 of computing device 40 via I/O interface(s) 306 of computing device 40. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, information relevant to drafting a document, wherein the information includes user input about an invention to be patented and prior art related to the invention, and wherein the document includes one or more sections of a patent application;
receiving, by one or more processors, guidelines and standards of patentability;
analyzing, by one or more processors, the received information;
determining, by one or more processors, the patentability of the invention, based on the analyzed received information, wherein determining the patentability of the invention comprises:
comparing, by one or more processors, the analysis of the received information to the received guidelines and standards of patentability and to the prior art related to the invention;
generating, by one or more processors, the document for the invention, based on a learned behavior; and
sending, by one or more processors, the generated document to the user.

2. The method of claim 1, wherein analyzing the received information comprises:
learning, by one or more processors, over a predetermined period of time through ontologies, information retrieval, natural language processing (NLP), natural language understanding and generation, speech recognition, machine learning, cognition, and artificial intelligence.

3. The method of claim 1, wherein analyzing the received information comprises:
learning, by one or more processors, a writing style of the user, wherein the writing style includes how the user drafted one or more previous patent applications.

4. The method of claim 1, wherein analyzing the received information comprises:
crawling, by one or more processors, through the received information to place the received information in categories for to assist in drafting a patent application.

5. The method of claim 1, wherein determining the patentability of the invention comprises:
assigning, by one or more processors, a scaled score to the invention within a predetermined scale, based on the comparison of the analysis of the received information to the received guidelines and standards of patentability and to the prior art related to the invention;
comparing, by one or more processors, the scaled score to a predetermined threshold score for patentability, wherein a scaled score equal to or above the predetermined threshold score of patentability signifies patentability of the invention; and
determining, by one or more processors, the patentability of the invention, based on the scaled score.

6. The method of claim 1, further comprising:
determining, by one or more processors, the invention is not patentable;
alerting, by one or more processors, the user that the invention is not patentable;
suggesting, by one or more processors, to the user, amendments to the invention to make the invention patentable; and
changing, by one or more processors, the invention, using the suggested amendments to make the invention patentable.

7. The method of claim 1, wherein sending the generated document to the user comprises:
receiving, by one or more processors, an approval from the user to send the generated document to an examining agency; and
sending, by one or more processors, the generated document directly to the examining agency.

8. A computer program product comprising:
one or more computer readable storage media and program instructions stored on the one or more computer readable storage media, the program instructions comprising:
program instructions to receive information relevant to drafting a document, wherein the information includes user input about an invention to be patented and prior art related to the invention, and wherein the document includes one or more sections of a patent application;
program instructions to receive guidelines and standards of patentability;
program instructions to analyze the received information;
program instructions to determine the patentability of the invention, based on the analyzed received information, wherein program instructions to determine the patentability of the invention comprise:
program instructions to compare the analysis of the received information to the received guidelines and standards of patentability and to the prior art related to the invention;
program instructions to generate the document for the invention, based on a learned behavior; and
program instructions to send the generated document to the user.

9. The computer program product of claim 8, wherein program instructions to analyze the received information comprise:
program instructions to learn over a predetermined period of time through ontologies, information retrieval, natural language processing (NLP), natural language understanding and generation, speech recognition, machine learning, cognition, and artificial intelligence.

10. The computer program product of claim 8, wherein program instructions to analyze the received information comprise:
program instructions to learn a writing style of the user, wherein the writing style includes how the user drafted one or more previous patent applications.

11. The computer program product of claim 8, wherein program instructions to analyze the received information comprise:
program instructions to crawl through the received information to place the received information in categories for to assist in drafting a patent application.

12. The computer program product of claim 8, wherein program instructions to determine the patentability of the invention comprise:
program instructions to assign a scaled score to the invention within a predetermined scale, based on the comparison of the analysis of the received information to the received guidelines and standards of patentability and to the prior art related to the invention;
program instructions to compare the scaled score to a predetermined threshold score for patentability, wherein a scaled score equal to or above the predetermined threshold score of patentability signifies patentability of the invention; and
program instructions to determine the patentability of the invention, based on the scaled score.

13. The computer program product of claim 8, further comprising:
program instructions, stored on the one or more computer readable storage media, to determine the invention is not patentable;
program instructions, stored on the one or more computer readable storage media, to alert the user that the invention is not patentable;
program instructions, stored on the one or more computer readable storage media, to suggest, to the user, amendments to the invention to make the invention patentable;
program instructions, stored on the one or more computer readable storage media, to change the invention, using the suggested amendments to make the invention patentable.

14. The computer program product of claim 8, wherein program instructions to send the generated document to the user comprise:
program instructions to receive an approval from the user to send the generated document to an examining agency; and
program instructions to send the generated document directly to the examining agency.

15. A computer system comprising:
one or more computer processors, one or more computer readable storage media, and program instructions stored on the one or more computer readable storage media for execution by at least one of the one or more computer processors, the program instructions comprising:
program instructions to receive information relevant to drafting a document, wherein the information includes user input about an invention to be patented and prior art related to the invention, and wherein the document includes one or more sections of a patent application;
program instructions to receive guidelines and standards of patentability;
program instructions to analyze the received information;
program instructions to determine the patentability of the invention, based on the analyzed received information, wherein program instructions to determine the patentability of the invention comprise:
program instructions to compare the analysis of the received information to the received guidelines and standards of patentability and to the prior art related to the invention;
program instructions to generate the document for the invention, based on a learned behavior; and
program instructions to send the generated document to the user.

16. The computer system of claim 15, wherein program instructions to analyze the received information comprise:
program instructions to learn over a predetermined period of time through ontologies, information retrieval, natural language processing (NLP), natural language understanding and generation, speech recognition, machine learning, cognition, and artificial intelligence.

17. The computer system of claim 15, wherein program instructions to analyze the received information comprise:
program instructions to learn a writing style of the user, wherein the writing style includes how the user drafted one or more previous patent applications.

18. The computer system of claim 15, wherein program instructions to analyze the received information comprise:
program instructions to crawl through the received information to place the received information in categories for to assist in drafting a patent application.

19. The computer system of claim 15, wherein program instructions to determine the patentability of the invention comprise:
program instructions to assign a scaled score to the invention within a predetermined scale, based on the comparison of the analysis of the received information to the received guidelines and standards of patentability and to the prior art related to the invention;
program instructions to compare the scaled score to a predetermined threshold score for patentability, wherein a scaled score equal to or above the predetermined threshold score of patentability signifies patentability of the invention; and
program instructions to determine the patentability of the invention, based on the scaled score.

20. The computer system of claim 15, further comprising:
program instructions, stored on the one or more computer readable storage media, to determine the invention is not patentable;
program instructions, stored on the one or more computer readable storage media, to alert the user that the invention is not patentable;
program instructions, stored on the one or more computer readable storage media, to suggest, to the user, amendments to the invention to make the invention patentable;
program instructions, stored on the one or more computer readable storage media, to change the invention, using the suggested amendments to make the invention patentable.
